(19) United States
(12) Patent Application Publication
(10) Pub. No.: US 2010/0247859 A1
(43) Pub. Date: Sep. 30, 2010

(54) METHOD FOR FABRICATING INJECTION-MOLDED PRODUCT

(75) Inventors: Sung-Sun PARK, Gyeongsangbuk-do (KR); Ha-Soo KIM, Gyeongsangbuk-do (KR); Hyon-Myong SONG, Daegu (KR); Seng-Ho AHN, Gyeongsangbuk-do (KR); Yong-Pil LIM, Gyeongsangbuk-do (KR); Sang-Beom KO, Gyeongsangbuk-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/732,453

(22) Filed: Mar. 26, 2010

(30) Foreign Application Priority Data
Mar. 27, 2009 (KR) 10-2009-0026377

(51) Int. Cl. B32B 3/30; B29C 45/16; B32B 3/00

(52) U.S. Cl. 428/141; 264/132; 428/172

(57) ABSTRACT

Provided is a method for fabricating an injection-molded product, including a molding step for forming a semi-transparent or transparent injection-molded product with patterns formed on the surfaces thereof by injecting a material in an injection mold, a first base coating step for forming a base coating layer on the inner surface of the injection-molded product where the patterns are formed, and a clear coating step for forming a clear coating layer on an outer surface of the injection-molded product, in which the base coating layer is formed of a base coat having a color therein. Furthermore, a painting or deposition of a metallic substance is performed on the inner surface of the injection-molded material where the patterns are formed, to impart an elegant metallic gloss resulting in a stereoscopic visual effect that can be viewed or felt from the exterior of the formed injection-molded product

### CLAIM OF PRIORITY

This application claims the benefit of the earlier filing date, under 35 U.S.C. §119(a), to that Korean Patent Application filed in the Korean Intellectual Property Office on Mar. 27, 2009 and assigned Serial No. 2009-26377, the entire disclosure of which is hereby incorporated by reference.

### BACKGROUND OF THE INVENTION

1. Field of the Invention

The present invention relates to injection-molding, and more particularly, to an injection-molded product fabricating method.

2. Description of the Related Art

An injection-molded product refers to a synthetic resin product fabricated in a shape formed in a molding die by injecting a melted resin into the molding die. Owing to easiness in mass production, the injection-molded process has been widely used to manufacture many different types of cases for many different types of items, e.g., daily necessities, electric appliances, electronic devices, and so forth.

In addition, the injection-molded process has been used for the manufacture of cosmetics cases, game consoles, and portable cellular phones. For many individuals, the cellular phone and other type of portable terminals articles and products (hereinafter referred to as portable terminals) have become a statement as to their style and fashion. With this trend, portable terminal users often purchase separate portable pouches or decorate their portable terminals with cases that can be mounted onto the terminals.

To meet users' various demands, much effort to diversify the exteriors of portable terminal cases has been made. For example, visual effects are provided by simply diversifying the colors of products (i.e., portable terminals), or in a complicated way, by coating a product with gradually changing colors or engraving a pattern on the surface of the product.

Engraving a pattern on an outer surface of an injection-molded product has been conventionally performed by using a separate film or through an extra printing step. By engraving a pattern in this way, new visual effects can be provided to the exterior of a portable article. However, such a conventional method of attaching a separate film or printing a pattern onto an outer surface of an injection-molded product makes it difficult to ensure durability of the pattern. That is, a portable terminal, by its nature, is likely to be exposed to an external environment and the pattern is prone to damage due to a shock, such as the fall of the portable article. Moreover, the method of attaching the film or printing the pattern simply provides a 2-dimensional (2D) visual effect, imposing a limitation in providing various satisfactions to users.

### SUMMARY OF THE INVENTION

An aspect of the present invention is to provide an injection-molded product fabricating method capable of providing various visual effects to an exterior of a case of a portable article, such as a cosmetics case and a case of a portable terminal.

Another aspect of the present invention is to provide an injection-molded product fabricating method capable of preventing visual decorations on an exterior of a portable terminal from being damaged by an exposure to an external environment or a shock.

According to an aspect of the present invention, there is provided a method for fabricating an injection-molded product, the method including a molding step for molding a semi-transparent or transparent injection-molded product with patterns formed on an inner surface thereof, a first base coating step for forming a base coating layer on the inner surface of the injection-molded product where the patterns are formed, and a clear coating step for forming a clear coating layer on an outer surface of the injection-molded product, in which the base coating layer is formed of a base coat having a color in the first base coating step.

In another aspect of the invention, a product produced by an injection-molding process wherein the product includes a semi-transparent or transparent element including a desired pattern, a base coating covering the semi-transparent or transparent element and a clear coat covering the base coat is disclosed. Structures for coupling with a counterpart injection-molded product may be formed on the inner surface of the injection-molded product, and the base coating layer formed on the structures may have a black-type color to hide the structures from the outer surface of the injection-molded product.

The method may further include, prior to the first base coating step, a deposition step for forming a tin (Sn) or silicon (Si) deposition layer on the inner surface of the injection-molded product, wherein metallic gloss in the color of the base coating layer provided by the tin or silicon deposition layer is viewed from the outer surface of the injection-molded product.

The method may further include, prior to the first base coating step, a painting step for painting the inner surface of the injection-molded product with metallic silver paints, wherein metallic gloss in the color of the base coating layer provided by the paints is viewed from the outer surface of the injection-molded product.

The method may further include, prior to the clear coating step, a second base coating step for forming a transparent base coating layer on the outer surface of the injection-molded product.

### BRIEF DESCRIPTION OF THE DRAWINGS

The above and other features and advantages of exemplary embodiments of the present invention will be more apparent from the following detailed description taken in conjunction with the accompanying drawings, in which:

FIG. 1 is a flowchart illustrating a method for fabricating an injection-molded product according to an embodiment of the present invention;

FIG. 2 is a flowchart illustrating a method for fabricating an injection-molded product according to another embodiment of the present invention;

FIG. 3 is a flowchart illustrating a method for fabricating an injection-molded product according to another embodiment of the present invention;

FIGS. 4 and 5 are perspective views illustrating molding dies used for molding an injection-molded product according to the present invention;

FIGS. 6A and 6B illustrate side views of an exemplary product in accordance with the principles of the invention.

### DETAILED DESCRIPTION OF THE INVENTION

Exemplary embodiments of the present invention will be described in detail with reference to the accompanying drawings. Detailed descriptions of well-known functions and constructions are omitted for clarity and conciseness.

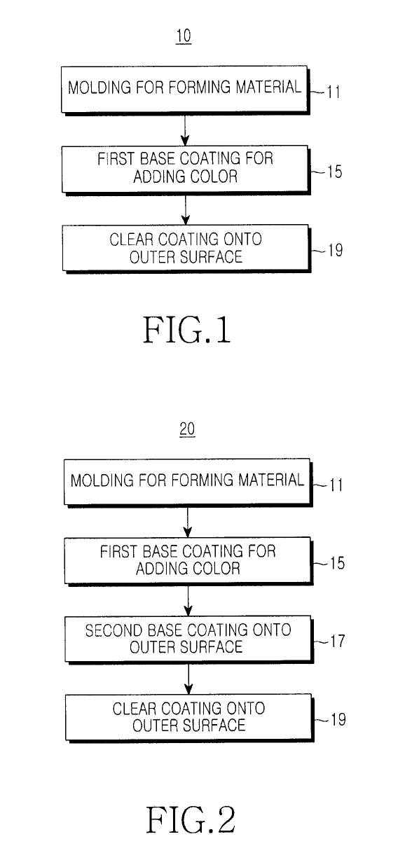

FIGS. 1 to 3 are flowcharts illustrating injection-molded product fabrication methods 10, 20, and 30 according to exemplary embodiments of the present invention. As shown in FIGS. 1 to 3, each of the injection-molded product fabrication methods 10, 20, and 30 includes a molding step 11 for molding a material, a first base coating step 15 for forming a color layer, by adding a color, onto an inner surface of the molded material if necessary, and a clear coating step 19 for forming a curing protective layer on an outer surface of the material. Some of the embodiments may further include, prior to the clear coating step 19, a second base coating step 17 for forming an additional curing protective layer on the outer surface of the material or a deposition step 13 for depositing tin (Sn) or silicon (Si) on the inner surface of the material to obtain metallic glossy effects.

The embodiments shown in FIGS. 1 to 3 commonly include the molding step 11, the first base coating step 15, and the clear coating step 19, and may selectively further include the second base coating step 17 or the deposition step 13. It should be noted that the common steps will be referred to as identical reference numerals, respectively, in the following description.

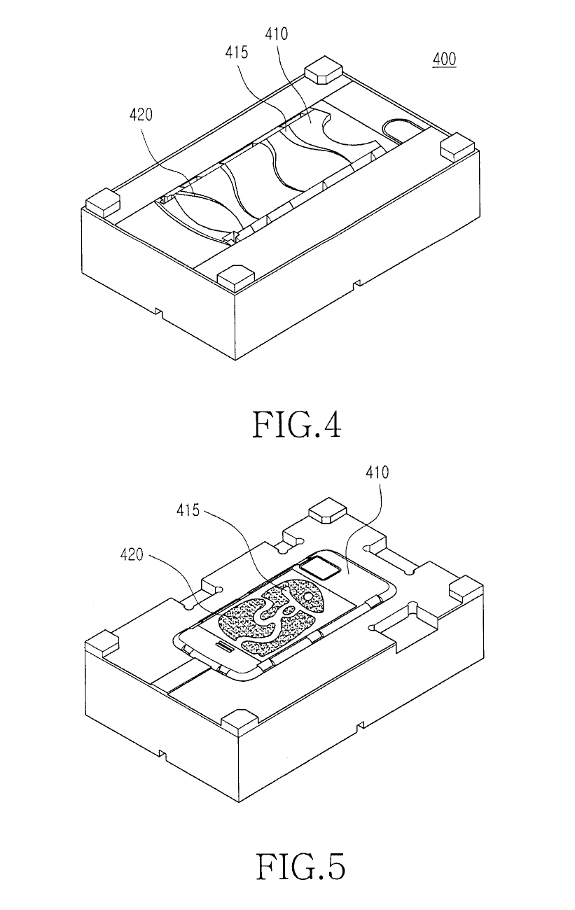

Referring to FIG. 1, the material is a mold fabricated by the molding step 11, and is molded by injecting a melting resin into a molding die. Various patterns are formed on an inner surface of the material, and the material is a semi-transparent or transparent material, whereby the patterns formed on the inner surface of the material can be seen from an outer surface of the material. FIGS. 4 and 5 illustrate parts of molding dies 400 used to mold the material. As shown in FIGS. 4 and 5, the patterns may be formed in a manner that extend inward 415 into the molding area 410 or outward 420 from the molding area 410. The shown molding die parts are intended to shape the inner surface of the material, in which patterns for shaping waves or wind and patterns such as Olympic symbol design, map design, etc. are provided.

A first base coating step 15 is a step for forming a base coating layer by applying a base coat to the inner surface of the material. A color of a final injection-molded product is determined by a color of the base coat used in the first base coating step 15. As can be understood by those of ordinary skill in the art, prior to the first base coating step 15, the inner and outer surfaces of the material may be cleaned and the material may be pre-heated to facilitate the formation of the base coating layer.

The clear coating step 19 is a step for forming a clear coating layer on the outer surface of the material, in which a coating liquid having an acrylic resin as its main component is applied to the outer surface of the material to form a curing protective layer which is transparent and glossy.

The injection-molded product fabrication method 10 includes at least the molding step 11, the first base coating step 15, and the clear coating step 19, a finished injection-molded product can be such that lattice patterns formed on the inner surface of the injection-molded product can be seen from the exterior and a color or shade changes according to viewing angle, thereby providing stereoscopic visual effects. And also, the exterior color is able to be implemented by using colored base coat in the first base coating step 15.

It can be easily understood by those of ordinary skill in the art that such an injection-molded product generally has a coupling structure, such as a groove or a protrusion (not shown), along the edge thereof to be coupled with a counterpart injection-molded product. The material is semi-transparent or transparent, so it is desirable to prevent degradation in the exterior of the finished injection-molded product by hiding the coupling structure from the exterior. To this end, the base coating layer of a black type may be formed on the coupling structure formed in the molding step 11.

Referring to FIG. 2, the injection-molded product fabrication method 20 according to another embodiment of the present invention further includes, prior to the clear coating step 19, the second base coating step 17 for forming an additional curing protective layer on the outer surface of the material. In the second base coating step 17, enhancement of compatibility or affinity between the material and the clear coating layer, as well as formation of the additional curing protective layer, is performed. Since the patterns have been formed on the inner surface of the material and the color of the injection-molded product has been determined in the first base coating step 15, a transparent base coat is applied to the outer surface of the material in the second base coating step 17. The second base coating may be of a transparent or a semi-transparent material and may further include a color that enhances or contrasts a color of the first base coating layer.

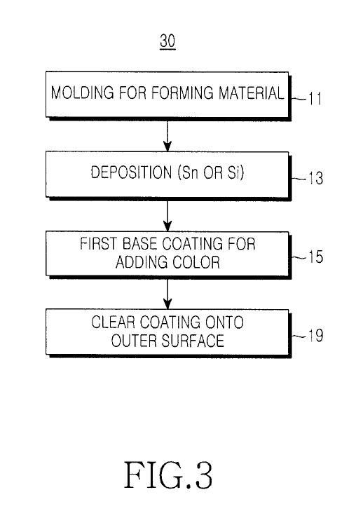

Referring to FIG. 3, the injection-molded product fabrication method 30 according to another embodiment of the present invention further includes, prior to the first base coating step 15, the deposition step 13 for depositing tin (Sn) or silicon (Si) on the inner surface of the material. Tin or silicon, by being deposited on the inner surface of the material, provides metallic gloss. The finished injection-molded product is formed with a deposition layer formed through the deposition step 13, from which it can be seen that the finished injection-molded product has metallic gloss.

The deposition step 13 may be substituted by a painting step if the painting step can provide such metallic gloss. In this case, it is desirable to use metallic silver paints in the painting step.

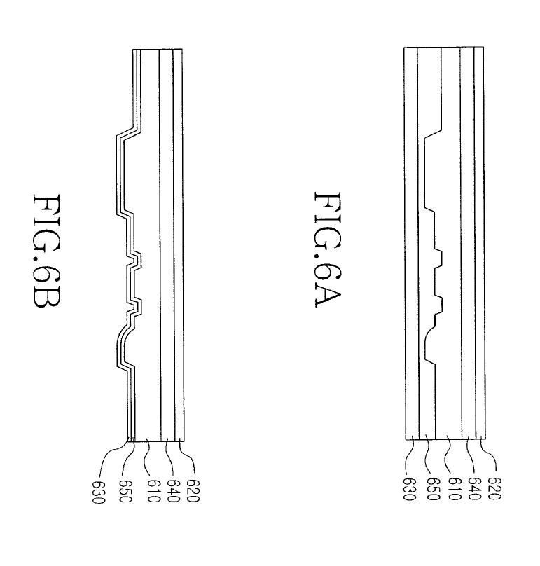

FIGS. 6A and 6B illustrate side views of a product produced according to the injection-molding process according to the principles of the invention. With reference to FIG. 6A, the material in the injection molding process is referred to as 610, the first base coat is 620, the clear coat is 630, the metal layer is 640 and the second base layer is 650. In FIG. 6A, the depositing of the layers in accordance to the principles of the invention are sized (i.e., thickness) to produce smooth inner and outer surfaces. With reference to FIG. 6B, uniform thickness layers 650 and 630 are placed on the material 610. In this case the protrusions (i.e., the pattern) from the material may be felt. The sizing (i.e., thickness) of layers 650 and 630 are thus that a tactile feel of the pattern may be achieved.

As is apparent from the foregoing description, according to the present invention, the patterns are formed on the inner surface of the injection-molded product of the transparent material, thereby providing various visual effects on the exterior of the finished injection-molded product. Moreover, because of being formed on the inner surface of the injection-molded product, the patterns can be protected from an exposure to an external environment or a shock, thus having superior durability. Furthermore, painting or deposition of a metallic substance is performed on the inner surface of the injection-molded product where the patterns are formed, so stereoscopic visual effects can be added to the exterior of the injection-molded product and the exterior of the injection-molded product looks elegant with metallic gloss.

While the present invention has been shown and described with reference to embodiments thereof, it will be understood by those skilled in the art that various changes in form and details may be made therein without departing from the spirit and scope of the invention as defined by the appended claims.

In addition, while the process described herein has been described with regard to portable terminals and other similar type devices, it would be recognized that the process described by also be applicable to other type of devices that may be stationary or not portable. For example, the process may be suitable to the fabrication of desktop computer cases, external hard drive cases, small electrical appliances, etc.

It would also be recognized from the teachings of the invention provided therein, that the second base coating step and the deposition step are selectively performed according to embodiments, but both of them may be performed in a single injection-molded product fabrication process.

What is claimed is:

1. A method for fabricating an injection-molded product, the method comprising:
a molding step for injecting a melting material into a mold element, the mold element including patterns formed on an inner surface thereof, the material being one of semi-transparent and transparent;
a first base coating step for forming a base coating layer on the inner surface of the material where the patterns are formed in the material; and
a clear coating step for forming a clear coating layer on an outer surface of the first base coat,
wherein the base coating layer creates a base coat having a desired color.

2. The method of claim 1, wherein structures for coupling with a counterpart injection-molded product are formed on the inner surface of the injection-molded product.

3. The method of claim 1, further comprising, prior to the first base coating step, a deposition step for forming a tin (Sn) or silicon (Si) deposition layer on the inner surface of the material, wherein a metallic gloss in the color of the base coating layer provided by the tin or silicon deposition layer is viewed from the outer surface of the material.

4. The method of claim 1, further comprising, prior to the first base coating step, a painting step for painting the inner surface of the material with a metallic silver paint, wherein a metallic gloss in the color of the base coating layer provided by the paints is viewed from the outer surface of the material.

5. The method of claim 1, further comprising, prior to the clear coating step, a second base coating step for forming a transparent base coating layer on the outer surface of the first base coating layer.

6. The method of claim 2, wherein the base coating layer formed on the structures has a black-type color to hide the structures from the outer surface of the material.

7. An injection-molded product comprising:
a material having at least one pattern formed therein, the pattern being one of extending into or from the material;
a first base coating layer deposited on the pattern of the material, the first base coating layer including a desired color; and
a clear coat layer deposited on the first base coating layer.

8. The product of claim 7, wherein the material is one of a semi-transparent and transparent material.

9. The product of claim 7, further comprising a metallic layer imposed between the material and the first base coating layer.

10. The product of claim 9, wherein the metallic layer is formed from a material selected as one of: tin (Sn) and silicon (Si).

11. The product of claim 9, wherein the metallic layer is deposited onto the material.

12. The product of claim 9, wherein the metallic layer is painted onto the material.

13. The product of claim 7, further comprising a second base coating layer imposed between the first base coating layer and the clear layer.

14. The product of claim 13, wherein the second base coating layer is one of: a transparent material and a semi-transparent material.

15. The product of claim 14, wherein the second base coating layer includes a desired color.

16. The product of claim 1, wherein the coating layers are sized to provide a smooth layer finish.

17. The product of claim 1, wherein the coating layers are sized to provide a tactile feel of the pattern through the layer finish.
